(19) United States
(12) Patent Application Publication
(10) Pub. No.: US 2018/0186177 A1
(43) Pub. Date: Jul. 5, 2018

(54) Roller Cover Remover

(71) Applicant: Bradley Jonathan Meyer, Wayne, PA (US)

(72) Inventor: Bradley Jonathan Meyer, Wayne, PA (US)

(21) Appl. No.: 15/383,693

(22) Filed: Dec. 19, 2016

(51) Int. Cl. B44D 3/00

(52) U.S. Cl. CPC B44D 3/006

(57) ABSTRACT

The Roller Cover Remover design, use and specifications are included in the Specification section. The product will be produced through an injection molding process using softer plastics. It is designed to cleanly and easily move wet roller covers from the cage of a roller quickly and also to be closed with a cap allowing for storage for later use desired.

The Roller Cover Remover will be produced using softer plastics which will allow a user to exert small amounts of pressure on the roller cover without damaging it.

The Roller Cover Remover will have a series of small raised round bumps on the exterior to allow for a secure grip.

The Roller Cover Remover will have a locking device to ensure device will be secure during the removal process and storage period if desired.

The Roller Cover Remover will have a living hinge design made of soft, flexible plastic which will prevent wet paint from accumulating between piano type hinge sections so as to prevent any impediment to functionality.

The Roller Cover Remover will have a slightly inward angled design on the open end so as to fit perfectly over the cover end piece and provide additional gripping and leverage to support the removal process. A cap will be available to insert in this end for closure during optional storage.

The Roller Cover shown in the drawings is designed to fit perfectly over standard roller covers. Alternate designs will include specifications for different size roller covers where applicable.

The Roller Cover Remover design may be varied during production to utilize more functional or cost effective materials that currently anticipated and described.

### BACKGROUND OF THE INVENTION

I work in the painting industry and have done many home and commercial painting projects. The single most annoying and frustrating aspect when working on any project, no matter how large or small, is switching from a used roller cover to a new one or simply removing a used roller cover at the end of the work day in a manner so that it does not get stuck on the roller, create additional clean-up effort, or damage the roller.

I usually, as do many other people in the industry that I have talked to, resort to using a plastic baggie, a towel or some other material to wrap around the cover to enable me to grip it, and then roughly pull it off the roller. While pulling it off, the excess paint on the cover invariably gets on everything in the vicinity, including the clean work area, clothes, hands, etc. The process of gripping the cover tight enough to be able to remove it also ruins the shape of the cover and often makes it unusable again.

I, and others I have worked with or observed, have frequently ended up, with less than one hundred percent success, removing covers by banging them on trash cans, the bed of our truck, or other hard surfaces, the result of which is to bend or warp the roller itself, making it difficult to install new covers or apply paint evenly. Simply put, the process of removing roller covers often damages rollers requiring replacement which adds unneeded expense to the cost of a given job.

I have also had to re-use roller covers on bigger project that require multiple applications or days to complete. I have had many roller covers dry out prematurely in between uses requiring replacement of covers to ensure job quality. Once again, the end result is additional time and money wasted.

The Roller Cover Remover saves time, wasted effort, and money while keeping the work site cleaner. These are hallmarks of customer satisfaction and service in the industry, while being invaluable to the professional as well as the do it yourself weekend painter.

### BRIEF SUMMARY OF THE INVENTION

The Roller Cover Remover is a plastic enclosure that clamps over the used roller cover and locks to keep we paint inside and prevents leaking or dripping. There is a hole at one end where the cover connects to the roller. The Remover is perfectly fitted to ensure that no additional paint drips or remains on the roller itself. There is also a cap that fits on the other end of the Remover that seals the moisture and air with the roller cover after it is removed. This allows it to stay perfectly shaped and moist for further usage. The Remover comes with one main grip used for everyday use, and two additional grips with liners for working with a variety of roller covers. It is perfectly sized to easily hold and has internal teeth that grab the roller cover to remove it without causing any damage to the roller. Because of this feature, removing the cover does not take significant effort and eliminates banging and other severe actions that cause damage and paint messes.

The Remover also comes with plastic liners that are disposable. These are placed in the grip before use and allow the grip to stay dry and clean so it can be used again and again with different covers so different paint types and colors do not inter-act.

The Remover grip itself is easily cleaned with warm wetter as it has a smooth plastic surface that does not readily retain any stray paint that might come into contact with it.

### BRIEF DESCRIPTION OF THE SEVERAL VIEWS OF THE DRAWINGS

FIG. 1 shows various views of the interior of the Roller Cover Remover in various open positions or angles with dimensions. More detail is provided in the cover sheet included with the drawings themselves.

FIG. 2 shows various views of the interior and exterior of the Roller Cover Remover in various positions with dimensions. More detail is provided in the cover sheet included with the drawings themselves.

FIG. 3 shows the living hinge design of the Roller Cover Remover to be made in Polypropylene and Polyethylene. More detail is provided in the cover sheet included with the drawings themselves.

FIG. 4 shows a CAD rendering of the Roller Cover in a fully open position showing the ribbed teeth and locking device. More detail is provided in the cover sheet included with the drawings themselves.

### DETAILED DESCRIPTION OF THE INVENTION

The Roller Cover Remover is a tool used to remove a used paint roller cover from a roller handle without making a mess, damaging the roller cage, or misshaping or denting the cover. This allows covers to be used multiple times and at the same time preserves the covers in a plastic liner so the paint on the cover remains keeping it wet and available for further use at any time without messy clean up.

The Remover is easy to use as it snaps closed over the wet cover while it is mounted on the roller cage. A cap end piece is placed on the end of the tool away from the roller handle to prevent excess paint from dripping or spattering. Once the Remover is in place it grips the used cover with ribbed teeth to grip a wet roller cover and with one simple pulling motion it is used to pull the used cover off the roller cage. The Roller Cover Remover will have a snap lock for use and storage and a living hinge. Prototype design included a traditional piano hinge. However the living hinge shown in the drawings is one piece of soft, flexible plastic which will prevent paint from accumulating the in the individual hinge pieces.

After the roller cover is pulled off the handle, an additional cap can be placed on the tool sealing the wet, cover inside the Remover in an airtight environment allowing for further use at any time.

The device also comes with disposable baggie type liners that are placed in the Remover and slide over the wet/used cover when inserted into the Remover. The cover can be removed from the Remover while inside the liner, which is zipped closed to keep the cover wet and re-usable. This frees up the Remover to be used on other wet and used covers.

The Remover is produced out of lightweight, “non-stick” plastic material that is easily washable after usage, which prevents any mixing of paint colors from multiple covers. A prototype has been made using the 3D printing process. Large scale production will use induction molding techniques to achieve greater economies of scale and quicker turn-around time. It will be made of a soft, resilient plastic to allow for tightening the grip on the Roller Cover Remover to have the teeth be more effective.

The tool is highly beneficial for the professional and do it yourself painter because the existing methods of removing used roller covers are difficult, messy, time wasting (especially for the professionals where time is money), and cause damage to the covers resulting in additional and unnecessary expense. These old ways of removing covers include banging them on trash can covers or other hard surfaces. The result is messy paint drips and spatters with damaged, unusable roller covers. When damaged covers are re-used they frequently do not apply paint smoothly leaving undesirable or unacceptable lines of paint on walls and surfaces.

Pulling the covers off roughly by hand using some available material such as rags or towels is very difficult because the wet rollers are slippery and hard to grip. When gripping tight enough by hand to successfully pull the cover off, paint drips and spatters occur as well as misshaping of the cover.

Another method is to wrap plastic over the wet roller directly to avoid gripping with a towel or rag, However the slippery nature of the plastic makes it difficult to get a secure grip without again having to squeeze so tightly so as to get undesired results.

The method of last resort is to avoid trying to remove wet covers and simply allow them dry out on the roller cage. This results in the wasted time of trying to scrape accumulated paint off of the used cover and then soak in paint when attempting to re-use it. This results in poor performance and shortened use-life (more expense) of the roller covers.

The benefits of the Roller Cover Remover are several. It provides a simple method to remove wet covers, providing faster, frustration free, more efficient and better clean up. Less time and more efficiency results in better profits for the professionals and more enjoyable free time for the do it yourself painter. The Remover eliminates the damage from bending, banging, warping, etc. to covers using old, annoying ways of removing wet covers. Most importantly, by not damaging the covers, it preserves them for multiple, effective uses, eliminating the need for premature replacement expenses. Lastly it produces better results in the quality of the painting job. This eliminates time consuming and expensive additional applications or touch-ups. These things are crucial to a job well done on a more profitable basis with less wasteful time and out of pocket expense, leading to satisfied customers whose referrals can make or break a business. The Roller Cover Remover is the tool that will make every painting job easier, less expensive while achieving higher quality results.

### DESCRIPTION OF THE DRAWINGS

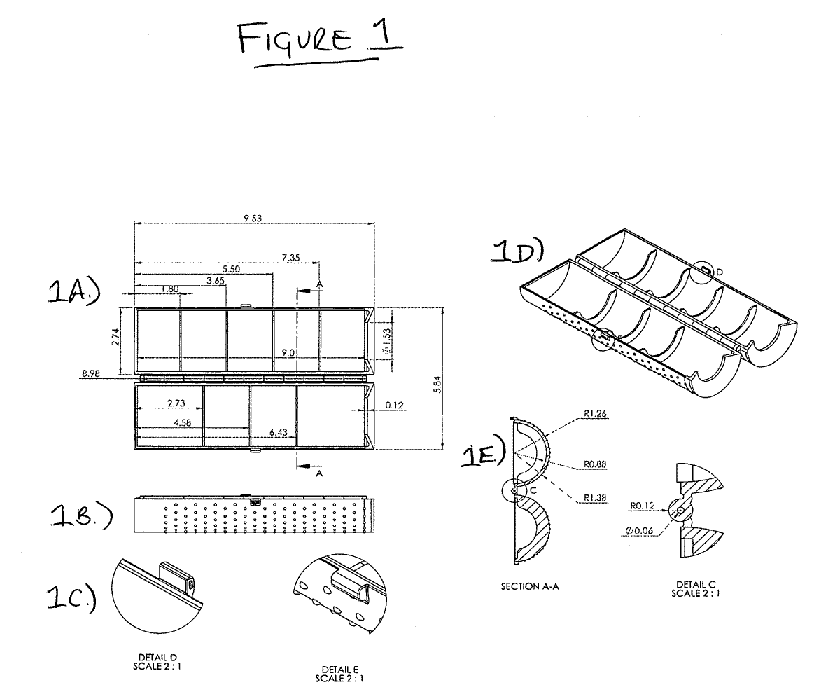

FIG. 1 in FIG. 1 A. shows an overhead view of the fully open Roller Cover Remover with dimensions. The dimensions sow over-all length, width of each piece, one with 3 teeth and one with 4 and the dimensions between them. Additionally the drawing shows a top piece sloped inward at a approximately a 20% angle. This feature allows for a perfect grip on the top end of the roller cover to ensure ease when removing.

FIG. 1 in FIG. 1 B. shows one half of the exterior of the Roller Cover Remover with piano hinge design made in the prototype but which will be a living hinge design in the future production. It also shows the gripping devices on the exterior to ensure better control when removing the roller cover.

FIG. 1 in FIG. 1 C. shows am angled view of the exterior locking device enlarge to scale as referenced in Detail D and Detail E.

FIG. 1 in FIG. 1 D. shows an angled view of the Roller Cover Remover in fully open position showing one side with three teeth and the other side with four teeth and small partial view of the exterior with gripping devices.

FIG. 1 in FIG. 1 E. shows and end view the open end of the Roller Cover Remover in open position showing the hinge area.

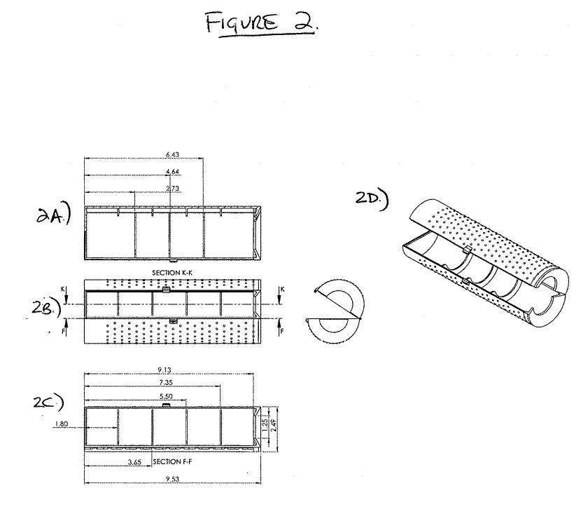

FIG. 2 in FIG. 2 A. shows an overhead view of the interior of the Roller Cover Remover in with dimensions of the three teeth side.

FIG. 2 in FIG. 2 B. shows an overhead view of the partially open Roller Cover Remover showing sections of the interior and exterior with the four teeth side visible with dimensions.

FIG. 2 in FIG. 2 C. shows an overhead view of the interior of the Roller Cover Remover in with dimensions of the four teeth side.

FIG. 2 in FIG. 2 D. shows a three quarter closed with of the Roller Cover Remover with the interior of the four teeth side visible.

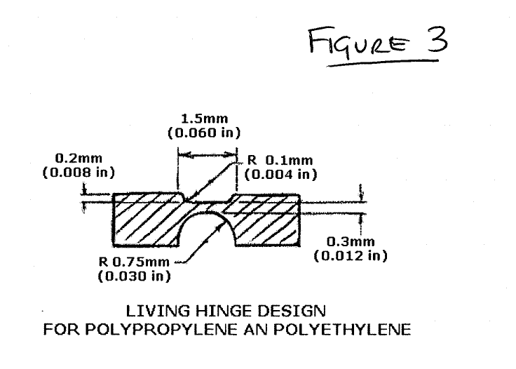

FIG. 3 shows the living hinge design of the Roller Cover Remover with dimensions produced in Polypropylene and Polyethylene.

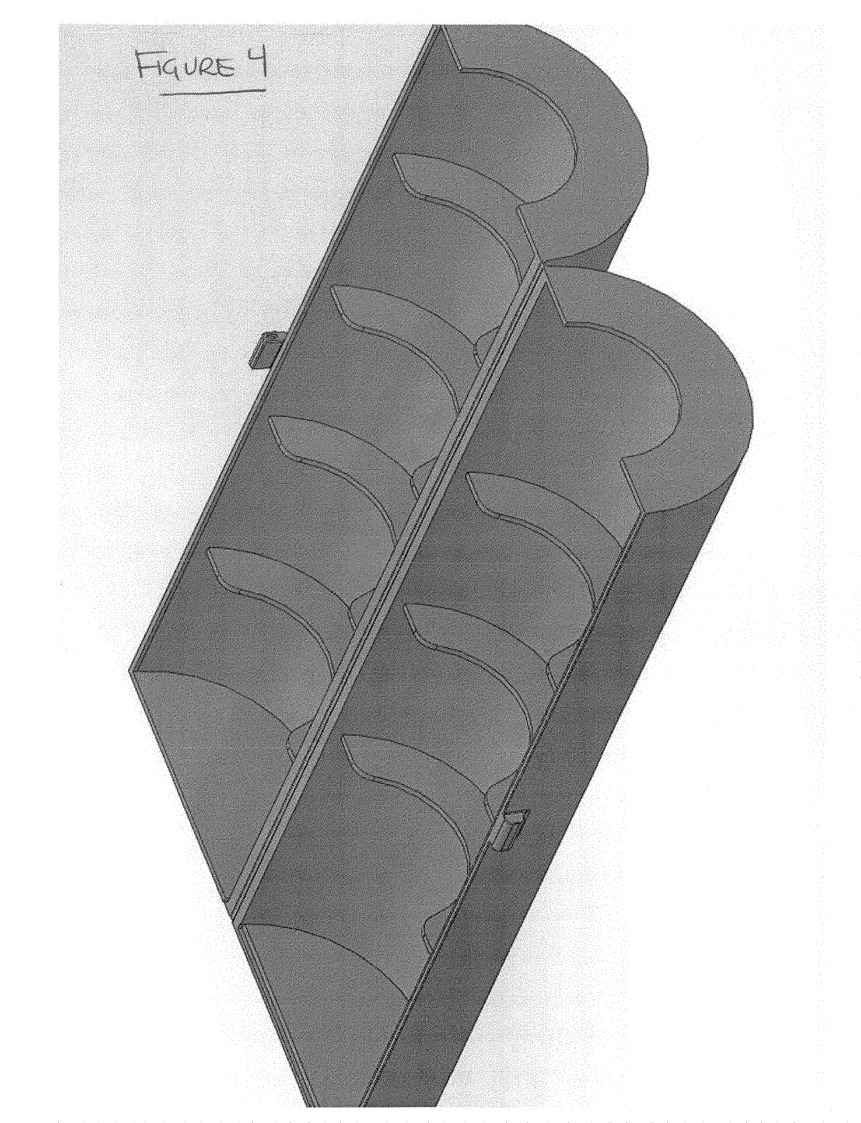

FIG. 4 shows a CAD rendering of the Roller Cover in a fully open position showing both the side with three ribbed teeth and the side with four ribbed teeth and the two parts of the locking device, one each located on each side. It is an angled view showing the open end of the Roller Cover Remover on the right from the exterior and the closed end on the left from the interior.

What is claimed is:

1. A unique product named a Roller Cover Remover has been invented for the purpose of removing a paint roller cover from the roller handle.

2. The unique design enables a user to grip the product, close a cover, and pull the roller cover cleanly and simply off the roller handle.

3. This product can then be closed with a cap for storage of the roller cover.

4. The Roller Cover Remover eliminates the mess or damage caused by having to grip a wet roller cover with a cloth or glove and try to yank it off the handle or having to bang the cover against a hard object to remove loosen it.

5. The Roller Cover Remover will save the expense of repeated purchases of roller covers due to damage caused in removing them.
